(19) United States
(12) Patent Application Publication
(10) Pub. No.: US 2025/0028150 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Ya-Hsiu WU, Taoyuan City (TW); Kai-Po FAN, Taoyuan City (TW); Ying-Jen WANG, Taoyuan City (TW); Sin-Jhong SONG, Taoyuan City (TW)

(21) Appl. No.: 18/778,265

(22) Filed: Jul. 19, 2024

Related U.S. Application Data
(60) Provisional application No. 63/514,958, filed on Jul. 21, 2023.

(51) Int. Cl. G02B 7/09; G02B 13/00; G03B 17/12

(52) U.S. Cl. CPC G02B 7/09; G03B 17/12; G02B 13/009; G03B 2205/0053

(57) ABSTRACT

An optical element driving mechanism is provided, including a first movable part, a fixed part, and a first driving assembly. The first movable part is connected to a first optical element. The first movable part is movable relative to the fixed part. The first driving assembly drives the first movable part to move relative to the fixed part

### CROSS REFERENCE TO RELATED APPLICATIONS

This application claims the benefit of U.S. Provisional Application No. 63/514,958, filed Jul. 21, 2023, the entirety of which is incorporated by reference herein.

### BACKGROUND OF THE INVENTION

### Field of the Invention

The present disclosure relates to an optical element driving mechanism, and more specifically, the present disclosure relates to an optical element driving mechanism for an electronic device.

### Description of the Related Art

As the relevant technologies have been developed, many electronic devices (such as computers and tablets) are equipped with the capability to record images and videos. However, when an optical element (such as lens) having a long focal length is provided in an electronic device, the thickness of the electronic device may be increased, impeding the prospects for miniaturization of the electronic device. Therefore, how to design an optical element driving mechanism and an optical device that may miniaturize the electronic device has become an important issue.

### BRIEF SUMMARY OF THE INVENTION

An embodiment of the present invention provides an optical element driving mechanism, including a first movable part, a fixed part, and a first driving assembly. The first movable part is connected to a first optical element. The first movable part is movable relative to the fixed part. The first driving assembly drives the first movable part to move relative to the fixed part.

### BRIEF DESCRIPTION OF THE DRAWINGS

The present invention may be more fully understood by reading the subsequent detailed description and examples with references made to the accompanying drawings, wherein:

FIG. 1 is a schematic view of an electrical device according to some embodiment of the present disclosure;

FIG. 2 is a schematic view of the optical element driving mechanism, the first optical element, and the second optical element according to some embodiments of the present disclosure, in which the outer frame is represented by a dotted line;

FIG. 3 is an exploded view of the optical element driving mechanism according to some embodiments of the present disclosure;

FIG. 4 is a cross-sectional view along line A-A′ of FIG. 2 of the optical element driving mechanism, the first optical element and the second optical element according to some embodiments of the present disclosure;

FIG. 5 is a cross-sectional view along line B-B′ of FIG. 2 of the optical element driving mechanism, the first optical element and the second optical element according to some embodiments of the present disclosure;

FIG. 6 is a perspective view of the first impact-absorbing element according to some embodiments of the present disclosure;

FIG. 7 is a perspective view of the second impact-absorbing element according to some embodiments of the present disclosure;

FIG. 8 is a cross-sectional view along line C-C′ of FIG. 2 of the optical element driving mechanism, the first optical element and the second optical element according to some embodiments of the present disclosure;

FIG. 9 is a cross-sectional view along line D-D′ of FIG. 2 of the optical element driving mechanism, the first optical element and the second optical element according to some embodiments of the present disclosure;

FIG. 10 is a cross-sectional view along line E-E′ of FIG. 2 of the optical element driving mechanism, the first optical element and the second optical element according to some embodiments of the present disclosure.

### DETAILED DESCRIPTION OF THE INVENTION

The making and using of optical systems of embodiments of the present disclosure are discussed in detail below. It should be appreciated, however, that the embodiments provide many applicable inventive concepts that may be embodied in a wide variety of specific contexts. The specific embodiments discussed are merely illustrative of specific ways to make and use the embodiments and do not limit the scope of the disclosure.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

It should be noted that the technical solutions provided by different embodiments below may be interchangeable, combined or mixed to form another embodiment without departing from the spirit of the present disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The scale of the drawings in the present disclosure may be drawn according to the actual size. The scale of the same figure in the present disclosure can be used as the actual manufacturing scale of the devices, equipment, elements, etc. of the present disclosure. It should be noted that each figure may be drawn at different orientations, which may result in different size ratios among different figures. However, the size ratio shown in an individual figure is not affect by the different size ratios between different figures. People with ordinary skill in the art can understand that the size ratio of the figures in the present disclosure can be used as a distinguishing feature from the prior art.

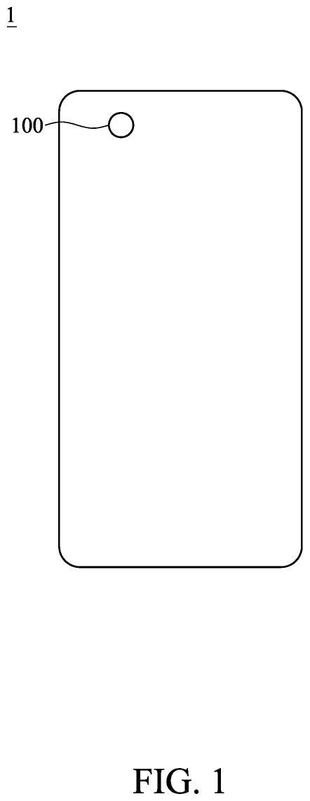

Firstly, please refer to FIG. 1, FIG. 1 is a schematic view of an electrical device 1 according to some embodiment of the present disclosure. As shown in FIG. 1, an optical system 100 of some embodiment of the present disclosure may be mounted in an electrical device 1 for taking photos or videos, wherein the aforementioned electrical device 1 may, for example, be a smartphone or a digital camera, but the present disclosure is not limited to these. It should be noted that the position and the size between the optical system 100 and the electrical device 1 shown in FIG. 1 are only an example, which is not for limiting the position and the size between the optical system 100 and the electrical device 1. In fact, according to different needs, the optical system 100 may be mounted at different positions in the electrical device 1.

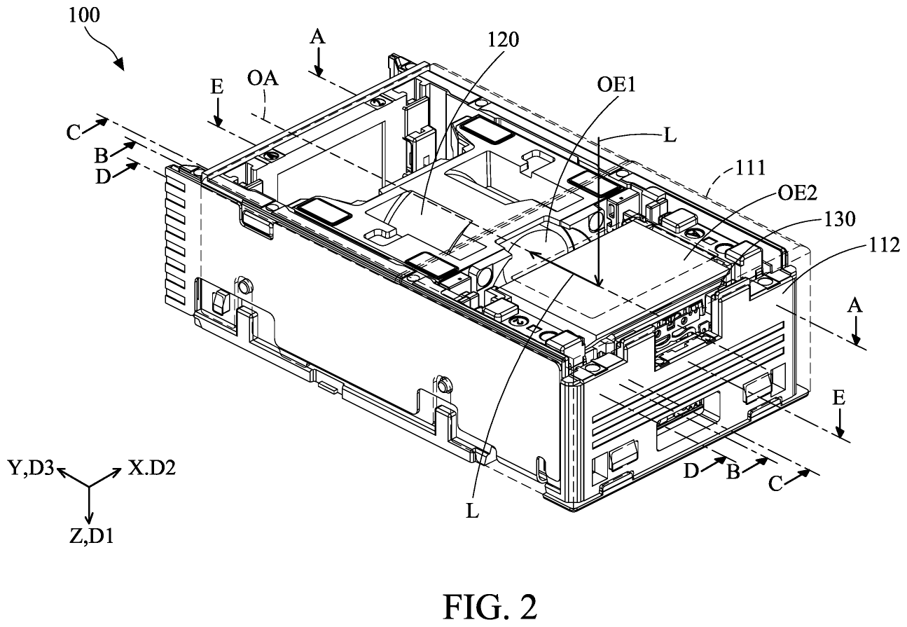

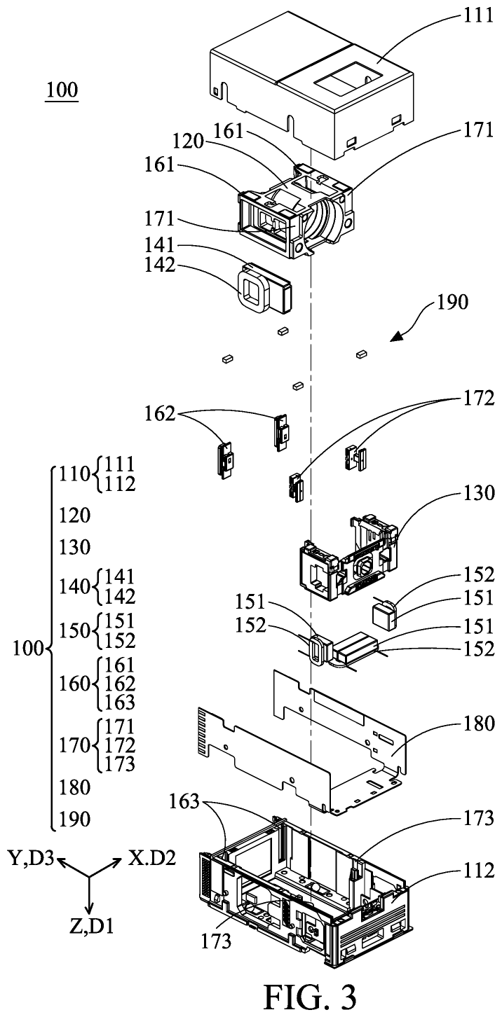

Please refer to FIG. 2 and FIG. 3. FIG. 2 is a schematic view of the optical element driving mechanism 100, the first optical element OE1, and the second optical element OE2 according to some embodiments of the present disclosure, in which the outer frame 111 is represented by a dotted line. FIG. 3 is an exploded view of the optical element driving mechanism 100 according to some embodiments of the present disclosure.

The optical element driving mechanism 100 may include a fixed part 110, a first movable part 120, a second movable part 130, a first driving assembly 140, a second driving assembly 150, a first stopping assembly 160, a second stopping assembly 170, a circuit assembly 180, and a connecting element 190.

The fixed part 110 may include an outer frame 111 and a base 112. The outer frame 111 is disposed on the base 112, and the outer frame 111 and the base 112 may be connected to each other to form an internal space to accommodate other elements of the optical element driving mechanism 100 or the first optical element OE1 and the second optical element OE2.

For example, the internal space formed by the outer frame 111 and the base 112 accommodates at least the first movable part 120, the second movable part 130, the first driving assembly 140, the second driving assembly 150, the first stopping assembly 160, and the second stop assembly 170.

As shown in FIG. 2, a light L may be incident to the second optical element OE2 from the outside of the optical element driving mechanism 100 along a first direction D1. The second optical element OE2 refracts and/or reflects the light L from the first direction D1 to be incident to the first optical element OE1 along the optical axis OA (which may also be the third direction D3 that is perpendicular to the first direction D1).

The first movable part 120 may be connected to the first optical element OE1, and the first movable part 120 may move relative to the fixed part 110. For example, the first movable part 120 may move along the optical axis OA relative to the fixed part 110, and the first optical element OE1 may move along the optical axis OA relative to the fixed part 110 along with the first movable part 120.

The second movable part 130 may be connected to the second optical element OE2, and the second movable part 130 may move relative to the fixed part 110. For example, the second movable part 130 may rotate relative to the fixed part 110 around the first direction D1 and the second direction D2 that are perpendicular to the optical axis OA, and the second optical element OE2 may move along with the second movable part 130 to rotate around the first direction D1 and the second direction D2 relative to the fixed part 110.

The first driving assembly 140 may drive the first movable part 120 to move relative to the fixed part 110. The first driving assembly 140 may include a first driving magnet 141 and a first driving coil 142. The first driving magnet 141 may be disposed on the first movable part 120, and the first driving coil 142 may be disposed on the base 112, so that when the first driving coil 142 receives current from the circuit assembly 180, the first driving magnet 141 drives the first movable part 120 to move along the optical axis OA relative to the fixed part 110.

The second driving assembly 150 may drive the second movable part 130 to move relative to the fixed part 110. The second driving assembly 150 may include three second driving magnets 151 and three second driving coils 152. The second driving magnet 151 may be disposed on the second movable part 130, and the second driving coil 152 may be disposed on the base 112, so that when the second driving coil 152 receives current from the circuit assembly 180, the second driving magnet 151 drives the second movable part 130 to move relative to the fixed part 110 around a direction that is perpendicular to the optical axis OA. For example, the second driving magnet 151 drives the second movable part 130 to rotate relative to the fixed part 110 around the first direction D1 and/or the second direction D2.

The first stopping assembly 160 may limit the movement range of the first movable part 120. The first stopping assembly 160 may include a first contacting element 161, a first impact-absorbing element 162, and a first fixing element 163.

The second stopping assembly 170 may limit the movement range of the first movable part 120. The second stopping assembly 170 may also limit the movement range of the second movable part 130. The second stopping assembly 170 may include a second contacting element 171, a second impact-absorbing element 172, and a second fixing element 173.

The circuit assembly 180 may be connected to an external circuit and electrically connected to the first driving assembly 140 and the second driving assembly 150. According to some embodiments of the present disclosure, the circuit assembly 180 may be electrically connected to the first driving coil 142 of the first driving assembly 140 and the second driving coil 152 of the second driving assembly 150.

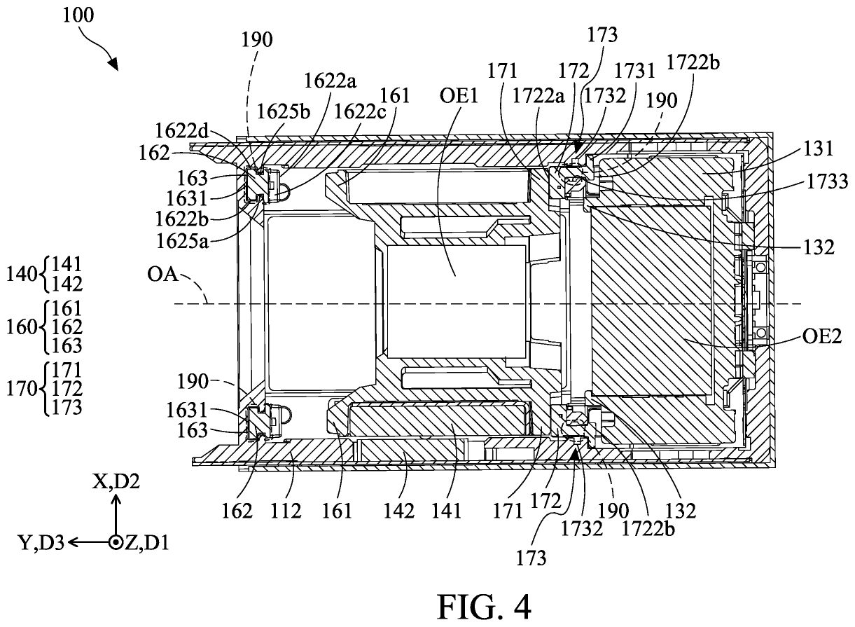

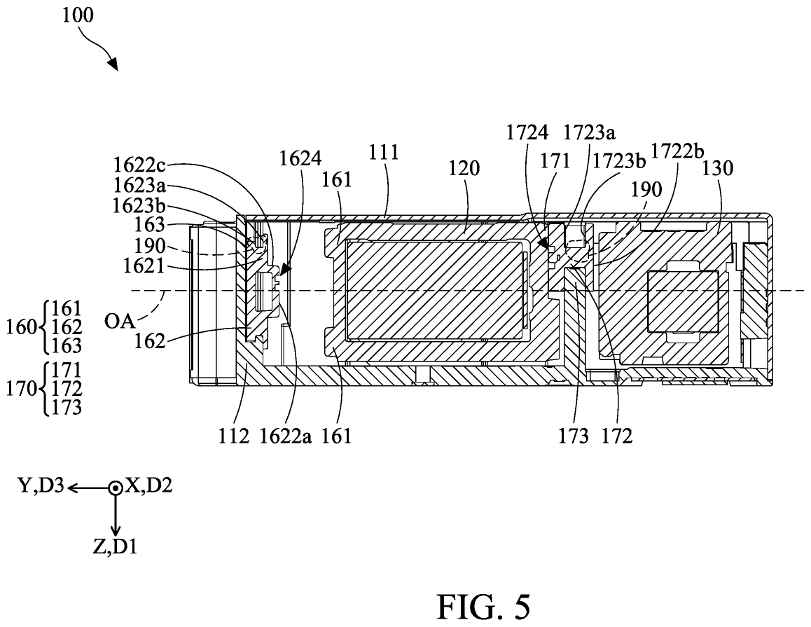

Please refer to FIG. 4 and FIG. 5. FIG. 4 is a cross-sectional view along line A-A′ of FIG. 2 of the optical element driving mechanism 100, the first optical element OE1 and the second optical element OE2 according to some embodiments of the present disclosure. FIG. 5 is a cross-sectional view along line B-B′ of FIG. 2 of the optical element driving mechanism 100, the first optical element OE1 and the second optical element OE2 according to some embodiments of the present disclosure.

As shown in FIG. 4 and FIG. 5, the first contacting element 161 is located on the first movable part 120, and the first fixing element 163 is located on the base 112. The first fixing element 163 may fix the first impact-absorbing element 162 so that the first impact-absorbing element 162 is fixed to the base 112. When the first movable part 120 is located at a first extreme position, the first impact-absorbing element 162 is in contact with the first contacting element 161 to limit the movement range of the first movable part 120.

According to some embodiments of the present disclosure, the Young's modulus of the first contacting element 161 is different from the Young's modulus of the first impact-absorbing element 162. According to some embodiments of the present disclosure, the Young's modulus of the first fixing element 163 is different from the Young's modulus of the first impact-absorbing element 162. According to some embodiments of the present disclosure, the Young's modulus of the first contacting element 161 is greater than the Young's modulus of the first impact-absorbing element 162. According to some embodiments of the present disclosure, the Young's modulus of the first fixing element 163 is greater than the Young's modulus of the first impact-absorbing element 162. According to some embodiments of the present disclosure, the Young's modulus of the first fixing element 163 is the same as the Young's modulus of the first contacting element 161.

The first impact-absorbing element 162 is at least partially located in a first groove 1631 of the first fixing element 163. The first impact-absorbing element 162 is connected to the first fixing element 163 via the connecting element 190.

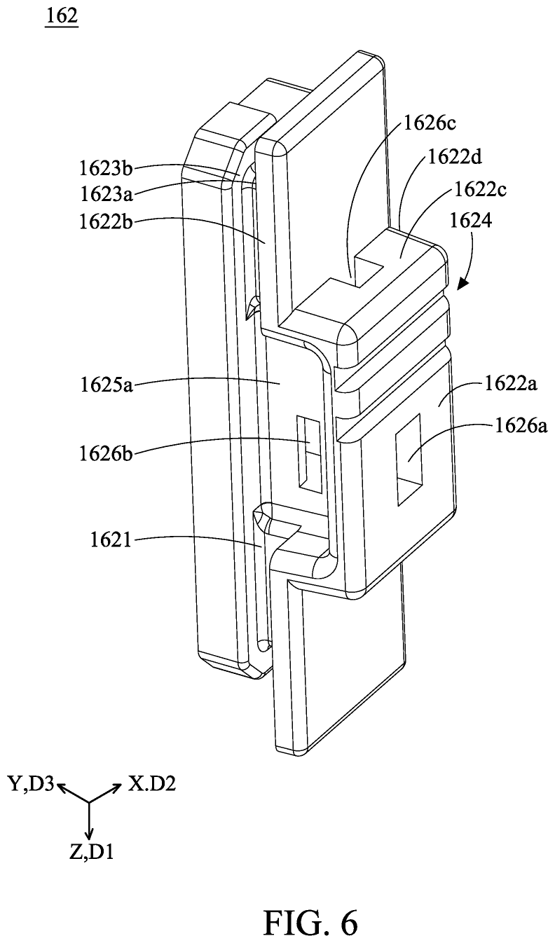

Please also refer to FIG. 6, FIG. 6 is a perspective view of the first impact-absorbing element 162 according to some embodiments of the present disclosure.

The first impact-absorbing element 162 may include a first impact-absorbing element body 1621, a first impact-absorbing element first surface 1622a, a first impact-absorbing element second surface 1622b, a first impact-absorbing element third surface 1622c, a first impact-absorbing element fourth surface 1622d, a first impact-absorbing element first fixed surface 1623a, a first impact-absorbing element second fixed surface 1623b, a first impact-absorbing element concave-convex structure 1624, a first impact-absorbing element first opening 1625a, a first impact-absorbing element second opening 1625b, a first impact-absorbing element first hollow portion 1626a, a first impact-absorbing element second hollow portion 1626b, and a first impact-absorbing element third hollow portion 1626c.

The first impact-absorbing element first surface 1622a is located on the first impact-absorbing element body 1621, and the first impact-absorbing element first surface 1622a faces the first contacting element 161. In detail, the first impact-absorbing element first surface 1622a is substantially perpendicular to the optical axis OA.

The first impact-absorbing element second surface 1622b is located on the first impact-absorbing element body 1621, and the first impact-absorbing element second surface 1622b is adjacent to the first impact-absorbing element first surface 1622a. The first impact-absorbing element second surface 1622b is not parallel to the first impact-absorbing element first surface 1622a. In detail, the first impact-absorbing element second surface 1622b is perpendicular to the second direction D2.

The first impact-absorbing element third surface 1622c is located on the first impact-absorbing element body 1621, and the first impact-absorbing element third surface 1622c is adjacent to the first impact-absorbing element first surface 1622a and the first impact-absorbing element second surface 1622b. The first impact-absorbing element third surface 1622c is not parallel to the first impact-absorbing element first surface 1622a and the first impact-absorbing element second surface 1622b. In detail, the first impact-absorbing element third surface 1622c is perpendicular to the first direction D1.

The first impact-absorbing element fourth surface 1622d is located on the first impact-absorbing element body 1621, and first impact-absorbing element fourth surface 1622d is adjacent to the first impact-absorbing element first surface 1622a and the first impact-absorbing element third surface 1622c. The first impact-absorbing element fourth surface 1622d is substantially parallel to the first impact-absorbing element second surface 1622b; however, the first impact-absorbing element fourth surface 1622d and the first impact-absorbing element second surface 1622b face opposite directions. In detail, the first impact-absorbing element fourth surface 1622d is perpendicular to the second direction D2.

The first impact-absorbing element first surface 1622a and the first impact-absorbing element second surface 1622b are located on the first impact-absorbing element body 1621. The first impact-absorbing element first fixed surface 1623a faces the first fixing element 163, and the first impact-absorbing element second fixed surface 1623b faces the first impact-absorbing element first fixed surface 1623a. The first impact-absorbing element first fixed surface 1623a and the first impact-absorbing element second fixed surface 1623b extend from the first impact-absorbing element third surface 1622c in a direction that is perpendicular to the first impact-absorbing element third surface 1622c, so that there is an accommodation space between the first impact-absorbing element first fixed surface 1623a and the first impact-absorbing element second fixed surface 1623b. The first impact-absorbing element first fixed surface 1623a extends farther away from the first impact-absorbing element third surface 1622c than the first impact-absorbing element second fixed surface 1623b (that is, the first impact-absorbing element first fixed surface 1623a is “higher” than the first impact-absorbing element second fixed surface 1623b).

The accommodation space between the first impact-absorbing element first fixed surface 1623a and the first impact-absorbing element second fixed surface 1623b is provided with the connecting element 190, such that the connecting element 190 may stay in the accommodation space between the first impact-absorbing element first fixed surface 1623a and the first impact-absorbing element second fixed surface 1623b. Moreover, the connecting element 190 does not flow out of the first impact-absorbing element first fixed surface 1623a, thereby making the optical element driving mechanism 100 more stable.

The first impact-absorbing element concave-convex structure 1624 is formed on the first impact-absorbing element first surface 1622a, and when the first movable part 120 is located at the first extreme position, the first impact-absorbing element concave-convex structure 1624 is in contact with the first contacting element 161.

The first impact-absorbing element first opening 1625a is formed on the first impact-absorbing element second surface 1622b, and the first impact-absorbing element second opening 1625b is formed on the first impact-absorbing element fourth surface 1622d, so that when viewed from the first direction D1, the impact-absorbing element 162 may have a substantially I-shape (see FIG. 4).

In this way, the Young's modulus of the first impact-absorbing element 162 may be reduced, thereby effectively limiting the movement range of the first movable part 120 and reducing the impact caused by the first movable part 120.

The first impact-absorbing element first hollow portion 1626a is formed on the first impact-absorbing element first surface 1622a of the first impact-absorbing element body 1621, and the first impact-absorbing element first hollow portion 1626a has an elongated structure. The first impact-absorbing element first hollow portion 1626a penetrates the first impact-absorbing element body 1621, and the first impact-absorbing element first hollow portion 1626a is parallel to the optical axis OA.

The first impact-absorbing element second hollow portion 1626b is formed on the first impact-absorbing element second surface 1622b of the first impact-absorbing element body 1621, and the first impact-absorbing element second hollow portion 1626b has an elongated structure. The first impact-absorbing element second hollow portion 1626b penetrates the first impact-absorbing element body 1621, and the first impact-absorbing element second hollow portion 1626b is perpendicular to the first impact-absorbing element first hollow portion 1626a In detail, the first impact-absorbing element second hollow portion 1626b is parallel to the second direction D2.

The third hollow portion 1626c of the first impact-absorbing element is formed on the third surface 1622c of the first impact-absorbing element body 1621, and the third hollow portion 1626c of the first impact-absorbing element has an elongated structure. The third hollow portion 1626c of the first impact-absorbing element penetrates the first impact-absorbing element body 1621, and the third hollow portion 1626c of the first impact-absorbing element is perpendicular to the first hollow portion 1626a and the second hollow portion 1626b of the first impact-absorbing element. In detail, the third hollow portion 1626c of the first impact-absorbing element is parallel to the first direction D1.

In this way, the Young's modulus of the first impact-absorbing element 162 may be reduced, thereby effectively limiting the movement range of the first movable part 120 and reducing the impact caused by the first movable part 120.

Please also refer to FIG. 4 and FIG. 5. The second contacting element 171 is located on the first movable part 120, and the second fixing element 173 is located on the base 112. The second fixing element 173 may fix the second impact-absorbing element 172 so that the second impact-absorbing element 172 is fixed to the base 112. When the first movable part 120 is located at a second extreme position, the second impact-absorbing element 172 is in contact with the second contacting element 171 to limit the movement range of the first movable part 120.

According to some embodiments of the present disclosure, the Young's modulus of the second contacting element 171 is different from the Young's modulus of the second impact-absorbing element 172. According to some embodiments of the present disclosure, the Young's modulus of the second fixing element 173 is different from the Young's modulus of the second impact-absorbing element 172. According to some embodiments of the present disclosure, the Young's modulus of the second contacting element 171 is greater than the Young's modulus of the second impact-absorbing element 172. According to some embodiments of the present disclosure, the Young's modulus of the second fixing element 173 is greater than the Young's modulus of the second impact-absorbing element 172. According to some embodiments of the present disclosure, the Young's modulus of the second fixing element 173 is the same as the Young's modulus of the second contacting element 171.

The second impact-absorbing element 172 is at least partially located in a second groove 1731 of the second fixing element 173. The second impact-absorbing element 172 is connected to the second fixing element 173 via the connecting element 190.

The second fixing element 173 includes a first groove 1732 and a second groove 1733. The first groove 1732 is recessed away from the second impact-absorbing element 172 along the second direction D2, and the second groove 1733 is also recessed away from the second impact-absorbing element 172 along the second direction D2. However, the concave direction of the first groove 1732 is opposite to the concave direction of the second groove 1733. The first groove 1732 and the second groove 1733 are provided with the connecting element 190, and the connecting element 190 is in contact with the second impact-absorbing element 172 to fix the second impact-absorbing element 172 to the second fixing element 173.

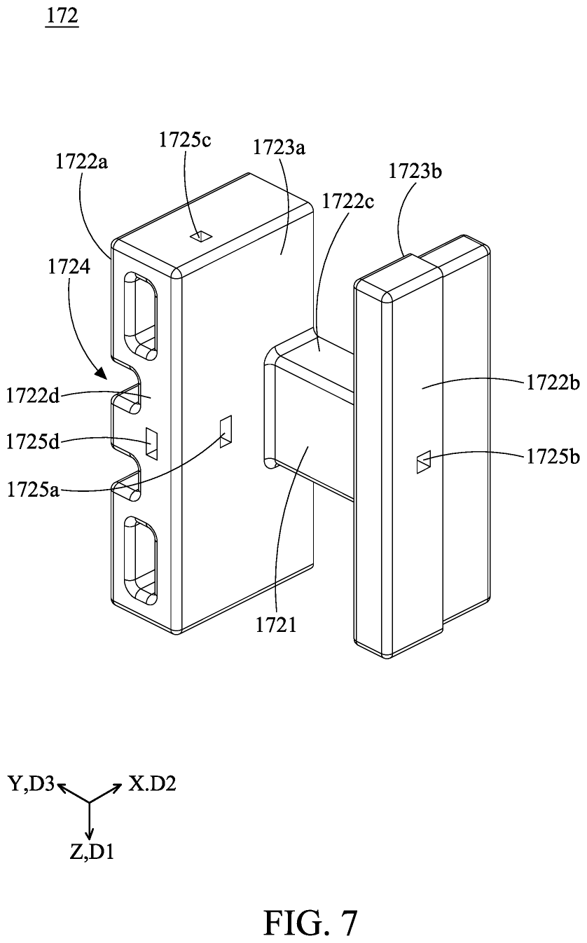

Please also refer to FIG. 7, FIG. 7 is a perspective view of the second impact-absorbing element 172 according to some embodiments of the present disclosure.

The second impact-absorbing element 172 may include a second impact-absorbing element body 1721, a second impact-absorbing element first surface 1722a, a second impact-absorbing element second surface 1722b, a second impact-absorbing element third surface 1722c, and a second impact-absorbing element fourth surface 1722d, a second impact-absorbing element first fixing surface 1723a, a second impact-absorbing element second fixing surface 1723b, a second impact-absorbing element concave-convex structure 1724, a second impact-absorbing element first hollow portion 1725a, a second impact-absorbing element second hollow portion 1725b, a second impact-absorbing element third hollow portion 1725c, and a second impact-absorbing element fourth hollow portion 1725d.

The second impact-absorbing element first surface 1722a is located on the second impact-absorbing element body 1721, and the second impact-absorbing element first surface 1722a faces the second contacting element 171. In detail, the second impact-absorbing element first surface 1722a is substantially perpendicular to the optical axis OA.

The second impact-absorbing element second surface 1722b is located on the second impact-absorbing element body 1721, and the second impact-absorbing element second surface 1722b faces away from the second contacting element 171. The second impact-absorbing element second surface 1722b is substantially parallel to the second impact-absorbing element first surface 1722a; however, the second impact-absorbing element second surface 1722b and the second impact-absorbing element first surface 1722a face opposite directions. In detail, the second surface 1722b of the second impact-absorbing element is substantially perpendicular to the optical axis OA.

The second impact-absorbing element first surface 1722a extends away from the second impact-absorbing element body 1721 along the second direction D2, and the second impact-absorbing element second surface 1722b also extends away from the second impact-absorbing element body 1721 along the second direction D2. However, the extending direction of the second impact-absorbing element first surface 1722a is opposite to the extending direction of the second impact-absorbing element second surface 1722b. When viewed from the first direction D1, the second impact-absorbing element 172 may have a substantially Z-shape (refer to FIG. 4).

In this way, the Young's modulus of the second impact-absorbing element 172 may be reduced, thereby effectively limiting the movement range of the first movable part 120 and reducing the impact caused by the first movable part 120.

The second impact-absorbing element third surface 1722c is located on the second impact-absorbing element body 1721, and the second impact-absorbing element third surface 1722c is adjacent to the second impact-absorbing element first surface 1722a. The second impact-absorbing element third surface 1722c and the second impact-absorbing element first surface 1722a are not parallel. In detail, the second impact-absorbing element third surface 1722c is perpendicular to the first direction D1.

The second impact-absorbing element fourth surface 1722d is located on the second impact-absorbing element body 1721, and the second impact-absorbing element fourth surface 1722d is adjacent to the second impact-absorbing element first surface 1722a and the second impact-absorbing element third surface 1722c. The second impact-absorbing element fourth surface 1722d is not parallel to the second impact-absorbing element first surface 1722a and the second impact-absorbing element third surface 1722c. In detail, the second impact-absorbing element fourth surface 1722d is perpendicular to the second direction D2.

The second impact-absorbing element first fixing surface 1723a and the second impact-absorbing element second fixing surface 1723b are located on the second impact-absorbing element body 1721. The second impact-absorbing element first fixing surface 1723a faces the second fixing element 173, and the second impact-absorbing element second fixing surface 1723b faces the second impact-absorbing element first fixing surface 1723a. The second impact-absorbing element first fixing surface 1723a and the second impact-absorbing element second fixing surface 1723b extend from the second impact-absorbing element third surface 1722c along the first direction D1, so that there is an accommodation space between the second impact-absorbing element first fixing surface 1723a and the second impact-absorbing element second fixing surface 1723b.

The accommodation space between the second impact-absorbing element first fixing surface 1723a and the second impact-absorbing element second fixing surface 1723b is provided with the connecting element 190, so that the connecting element 190 may stay in the accommodation space between the second impact-absorbing element first fixing surface 1723a and the second impact-absorbing element second fixing surface 1723b. Moreover, the connecting element 190 does not flow out from the second impact-absorbing element first fixing surface 1723a, thereby making the optical element driving mechanism 100 more stable.

The second impact-absorbing element concave-convex structure 1724 is formed on the second impact-absorbing element first surface 1722a, and when the first movable part 120 is located at the second extreme position, the second impact-absorbing element concave-convex structure 1724 is in contact with the second contacting element 171.

In this way, the Young's modulus of the second impact-absorbing element 172 may be reduced, thereby effectively limiting the movement range of the first movable part 120 and reducing the impact caused by the first movable part 120.

The second impact-absorbing element first hollow portion 1725a is formed on the second impact-absorbing element first surface 1722a on the second impact-absorbing element body 1721, and the second impact-absorbing element first hollow portion 1725a has an elongated structure. The second impact-absorbing element first hollow portion 1725a penetrates the second impact-absorbing element body 1721, and the second impact-absorbing element first hollow portion 1725a is parallel to the optical axis OA.

The second impact-absorbing element second hollow portion 1725b is formed on the second impact-absorbing element second surface 1722b on the second impact-absorbing element body 1721, and the second impact-absorbing element second hollow portion 1725b has an elongated structure. The second impact-absorbing element second hollow portion 1725b penetrates the second impact-absorbing element body 1721 and reaches the second impact-absorbing element first surface 1722a, and the second impact-absorbing element second hollow portion 1725b is parallel to the second impact-absorbing element first hollow portion 1725a. In detail, the second impact-absorbing element second hollow portion 1725b is parallel to the optical axis OA.

The second impact-absorbing element third hollow portion 1725c has an elongated structure. The second impact-absorbing element third hollow portion 1725c penetrates the second impact-absorbing element body 1721, and the second impact-absorbing element third hollow portion 1725c is perpendicular to the second impact-absorbing element first hollow portion 1725a and the second impact-absorbing element second hollow portion 1725b. In detail, the second impact-absorbing element third hollow portion 1725c is parallel to the first direction D1.

The second impact-absorbing element fourth hollow portion 1725d is formed on the second impact-absorbing element fourth surface 1722d on the second impact-absorbing element body 1721, and the second impact-absorbing element fourth hollow portion 1725d has an elongated structure. The second impact-absorbing element fourth hollow portion 1725d penetrates the second impact-absorbing element body 1721, and the second impact-absorbing element fourth hollow portion 1725d is perpendicular to the second impact-absorbing element first hollow portion 1725a, the second impact-absorbing element second hollow portion 1725b, and second impact-absorbing element third hollow portion 1725c. In detail, the second impact-absorbing element fourth hollow portion 1725d is parallel to the second direction D2.

In this way, the Young's modulus of the second impact-absorbing element 172 may be reduced, thereby effectively limiting the movement range of the first movable part 120 and reducing the impact caused by the first movable part 120.

Please continue to refer to FIG. 4 and FIG. 5. The second impact-absorbing element second surface 1722b faces the second movable part 130. When the second movable part 130 reaches a second movable part extreme first position around the first direction D1, the second impact-absorbing element second surface 1722b of the second impact-absorbing element 172 is in contact with the second movable part 130 to limit the movement range of the second movable part 130.

It should be understood that when the second movable part 130 moves around the first direction D1 to the second movable part extreme first position, the second movable part 130 will also be in contact with the outer frame 111 and the base 112 of the fixed part 110 to limit the movement range of the second movable part 130.

Through the outer frame 111, the base 112, and the second impact-absorbing element 172, the movement range of the second movable part 130 around the first direction D1 may be more effectively limited, and the impact caused by the second movable part 130 may be reduced.

When the second movable part 130 reaches a second movable part extreme second position around the second direction D2, the second impact-absorbing element second surface 1722b of the second impact-absorbing element 172 is in contact with the second movable part 130 to limit the movement range of the second movable part 130.

It should be understood that when the second movable part 130 reaches a second movable part extreme second position around the second direction D2, the second movable part 130 will also be in contact with the base 112 of the fixed part 110 to limit the movement range of the second movable part 130.

Through the base 112 and the second impact-absorbing element 172, the movement range of the second movable part 130 may be more effectively limited, and the impact caused by the second movable part 130 may be reduced.

When the second movable part 130 is impacted and moves along the direction of the optical axis OA, the second impact-absorbing element second surface 1722b of the second impact-absorbing element 172 is in contact with the second movable part 130 to limit the movement range of the second movable part 130. Through the second impact-absorbing element 172, the impact suffered by the second movable part 130 may be more effectively reduced.

That is, the second impact-absorbing element 172 may limit the movement range of the first movable part 120 and the second movable part 130; in other words, the first movable part 120 and the second movable part 130 “share” the second stopping assembly 170. In this way, the number of elements required for the optical element driving mechanism 100 may be reduced, thereby achieving miniaturization of the optical element driving mechanism 100.

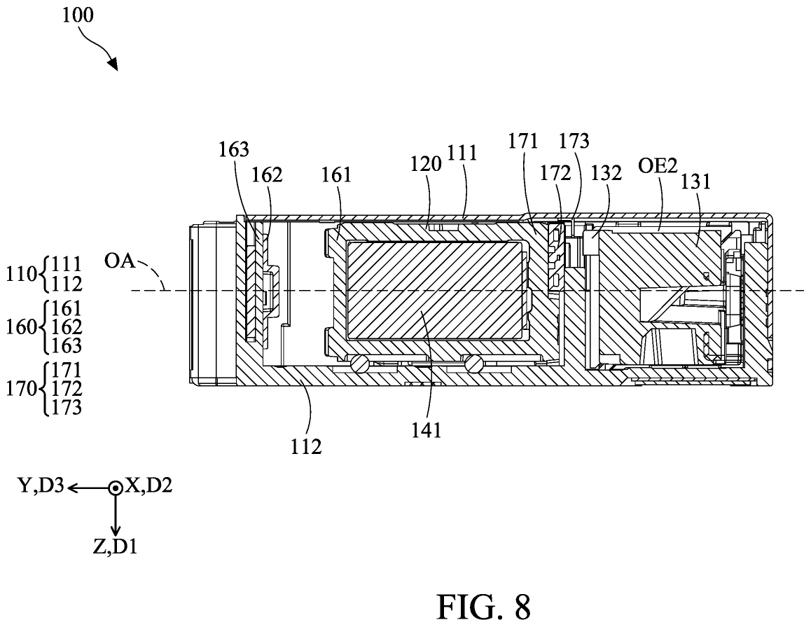

Please also refer to FIG. 4 and FIG. 8. FIG. 8 is a cross-sectional view along line C-C′ of FIG. 2 of the optical element driving mechanism 100, the first optical element OE1 and the second optical element OE2 according to some embodiments of the present disclosure.

As shown in FIG. 4 and FIG. 8, the first movable part 120, the first stopping assembly 160, and the second stopping assembly 170 are arranged along the optical axis OA, and the first driving assembly 140 drives the first movable part 120 to move relative to the fixed part 110 along the optical axis OA through a first driving force 100F. The first stopping assembly 160, the first driving force 100F, and the second stopping assembly 170 overlap with each other along the optical axis OA.

In this way, the first stopping assembly 160 and the second stopping assembly 170 may directly absorb the impact caused by the first driving force 100F, thereby effectively limiting the movement range of the first movable part 120. Furthermore, instability of the optical element driving mechanism 100 caused by bias of driving forces may be avoided.

Please continue to refer to FIG. 4 and FIG. 8. The second movable part 130 includes a second movable part body 131 and a hook portion 132.

The second movable part body 131 and the hook portion 132 are in contact with the second optical element OE2, and the hook portion 132 is in contact with the second optical element OE2, and the hook portion 132 extends away from the second movable part body 131 along the optical axis OA, such that the second optical element OE2 is located between the second movable part body 131 and the hook portion 132.

In this way, the second optical element OE2 may be effectively fixed between the second movable part body 131 and the hook portion 132 to prevent the second optical element OE2 from being loosened from the second movable part 130.

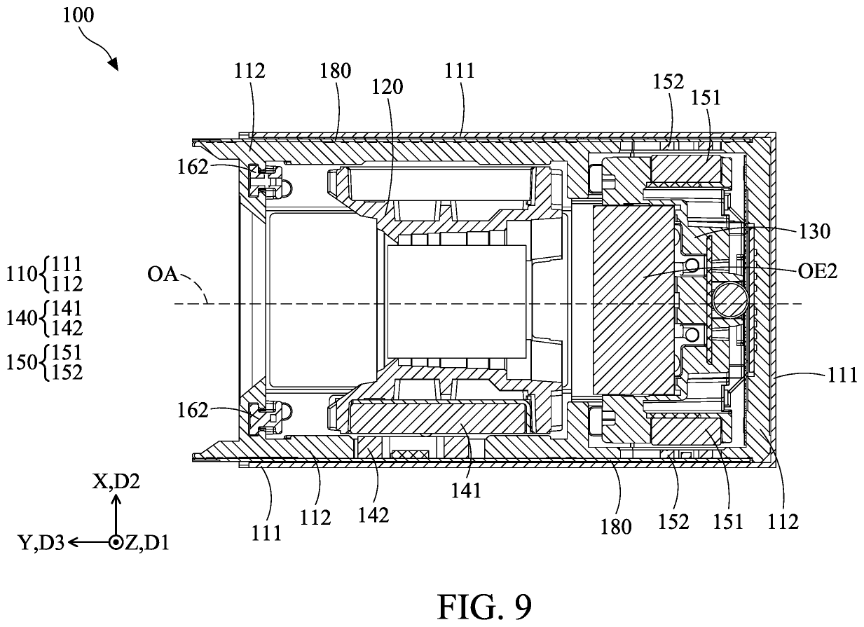

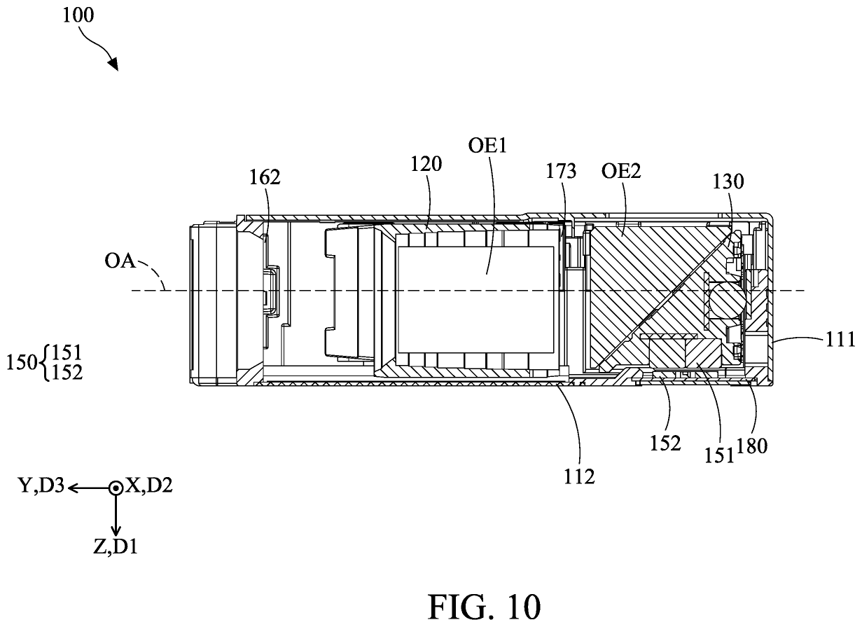

Please refer to FIG. 9 and FIG. 10. FIG. 9 is a cross-sectional view along line D-D′ of FIG. 2 of the optical element driving mechanism 100, the first optical element OE1 and the second optical element OE2 according to some embodiments of the present disclosure. FIG. 10 is a cross-sectional view along line E-E′ of FIG. 2 of the optical element driving mechanism 100, the first optical element OE1 and the second optical element OE2 according to some embodiments of the present disclosure.

As shown in FIG. 9 and FIG. 10, in the direction (which may be the second direction D2) that is perpendicular to the optical axis OA and parallel to the base 112, the first movable part 120 at least partially overlaps the outer frame 111, and the second movable part 130 at least partially overlap the outer frame 111.

In the direction (which may be the first direction D1) that is perpendicular to the optical axis OA and is perpendicular to the base 112, the first movable part 120 at least partially overlaps the outer frame 111, and the second movable part 130 at least partially overlaps the outer frame 111.

As shown in FIG. 9 and FIG. 10, in a direction (which may be the second direction D2) that is perpendicular to the optical axis OA and is parallel to the base 112, the first movable part 120 at least partially overlaps the base 112, and the second movable part 130 at least partially overlaps the base 112.

In a direction (which may be the first direction D1) that is perpendicular to the optical axis OA and is perpendicular to the base 112, the first movable part 120 at least partially overlaps the base 112, and the second movable part 130 at least partially overlaps the base 112.

As shown in FIG. 9 and FIG. 10, in the direction (which may be the second direction D2) that is perpendicular to the optical axis OA and parallel to the base 112, the first driving assembly 140 at least partially overlaps the outer frame 111 (may refer to FIG. 8), and the second driving assembly 150 at least partially overlaps the outer frame 111.

In the direction (which may be the first direction D1) that is perpendicular to the optical axis OA and is perpendicular to the base 112, the first driving assembly 140 at least partially overlaps the outer frame 111, and the second driving assembly 150 at least partially overlaps the outer frame 111.

As shown in FIG. 9 and FIG. 10, in a direction perpendicular to the optical axis OA and parallel to the base 112 (which may be the second direction D2), the first driving assembly 140 at least partially overlaps the base 112 (refer to FIG. 8), and the second driving assembly 150 at least partially overlaps the base 112.

In the direction (which may be the first direction D1) that is perpendicular to the optical axis OA and perpendicular to the base 112, the first driving assembly 140 at least partially overlaps the base 112, and the second driving assembly 150 at least partially overlaps the base 112.

That is, the outer frame 111 and the base 112 may accommodate the first movable part 120, the second movable part 130, the first driving assembly 140 and the second driving assembly 150 at the same time; in other words, the first movable part 120, the second movable part 130, the first driving assembly 140 and the second driving assembly 150 “share” the outer frame 111 and the base 112. In this way, the number of elements required for the optical element driving mechanism 100 may be reduced, thereby achieving miniaturization of the optical element driving mechanism 100.

Please continue to refer to FIG. 9 and FIG. 10. The circuit assembly 180 is disposed on the base 112. In the direction (which may be the second direction D2) that is perpendicular to the optical axis OA and parallel to the base 112, the second movable part 130 at least partially overlaps the circuit assembly 180.

In the direction (which may be the first direction D1) that is perpendicular to the optical axis OA and is perpendicular to the base 112, the first movable part 120 at least partially overlaps the circuit assembly 180, and the second movable part 130 at least partially overlaps the circuit assembly 180.

As shown in FIG. 9 and FIG. 10, in the direction (which may be the second direction D2) that is perpendicular to the optical axis OA and is parallel to the base 112, the second driving assembly 150 at least partially overlaps the circuit assembly 180.

In the direction (which may be the first direction D1) that is perpendicular to the optical axis OA and is perpendicular to the base 112, the first driving assembly 140 at least partially overlaps the circuit assembly 180, and the second driving assembly 150 at least partially overlaps the circuit assembly 180.

That is, the first driving assembly 140 and the second driving assembly 150 may receive the current from the circuit assembly 180 to drive the first movable part 120 and the second movable part 130, respectively; in other words, the first movable part 120, the second movable part 130, the first driving assembly 140 and the second driving assembly 150 “share” the circuit assembly 180. In this way, the number of element required for the optical element driving mechanism 100 may be reduced, thereby achieving miniaturization of the optical element driving mechanism 100.

In summary, the concave-convex structure, hollow portion, and appearance of the first impact-absorbing element and the second impact-absorbing element of the optical element driving mechanism of the embodiments of the present disclosure may reduce the impact of the first movable part and the second movable part. Moreover, the optical element driving mechanism of the embodiment of the present disclosure may “share” the outer frame, the base, the second stopping assembly, and the circuit assembly, so that the optical element driving mechanism of the embodiments of the present disclosure may be miniaturized, light-weighting, and improved its stability, so that users can operate the optical element driving mechanism smoothly and obtain better imaging effects.

Although embodiments of the present disclosure and their advantages have been described in detail, it should be understood that various changes, substitutions and alterations may be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure.

Accordingly, the appended claims are intended to include within their scope such processes, machines, manufacture, compositions of matter, means, methods, or steps. In addition, the scope of the present disclosure is defined by the scope of the appended claims. In addition, each scope of the claims is constructed as a separate embodiment, and various combinations of the claims and combinations of embodiments are within the scope of the present disclosure.

What is claimed is:

1. An optical element driving mechanism, comprising:
a first movable part, connected to a first optical element;
a fixed part, wherein the first movable part is movable relative to the fixed part; and
a first driving assembly, driving the first movable part to move relative to the fixed part.

2. The optical element driving mechanism as claimed in claim 1, further comprising:
a first stopping assembly, limiting a movement range of the first movable part,
wherein the first stopping assembly comprises:
a first contacting element;
a first impact-absorbing element, wherein when the first movable part is at a first extreme position, the first impact-absorbing element is in contact with the first contacting element; and
a first fixing element, fixing the first impact-absorbing element.

3. The optical element driving mechanism as claimed in claim 2,
wherein the first impact-absorbing element comprises:
a first impact-absorbing element body;
a first impact-absorbing element first surface, located on the first impact-absorbing element body and faces the first contacting element;
a first impact-absorbing element second surface, adjacent to the first impact-absorbing element first surface and not parallel to the first impact-absorbing element first surface;
a first impact-absorbing element first opening, formed on the first impact-absorbing element second surface; and
a first impact-absorbing element concave-convex structure, formed on the first impact-absorbing element first surface,
wherein when the first movable part is located at the first extreme position, the first impact-absorbing element concave-convex structure is in contact with the first contacting element.

4. The optical element driving mechanism as claimed in claim 3,
wherein the first impact-absorbing element further comprises:
a first impact-absorbing element first fixed surface, facing the first fixing element; and
a first impact-absorbing element second fixed surface, facing the first impact-absorbing element first fixed surface;
wherein the first impact-absorbing element is at least partially located in a first groove of the first fixing element.

5. The optical element driving mechanism as claimed in claim 4,
wherein the first impact-absorbing element further comprises:
a first impact-absorbing element third surface, adjacent to the first impact-absorbing element first surface and not parallel to the first impact-absorbing element first surface and the first impact-absorbing element second surface,
wherein the first impact-absorbing element first fixed surface and the first impact-absorbing element second fixed surface extend from the first impact-absorbing element third surface in a direction that is perpendicular to the first impact-absorbing element third surface, and
wherein the first impact-absorbing element first fixed surface extends farther away from the first impact-absorbing element third surface than the first impact-absorbing element second fixed surface.

6. The optical element driving mechanism as claimed in claim 4, further comprising:
a connecting element,
wherein the connecting element is disposed between the first impact-absorbing element first fixed surface and the first impact-absorbing element second fixed surface, and
wherein the first impact-absorbing element is connected to the first fixing element via the connecting element.

7. The optical element driving mechanism as claimed in claim 2,
wherein the first impact-absorbing element further comprises:
a first impact-absorbing element first hollow portion, formed on the first impact-absorbing element body and has an elongated structure,
wherein the first impact-absorbing element first hollow portion penetrates the first impact-absorbing element body, and the first impact-absorbing element first hollow portion is parallel to an optical axis.

8. The optical element driving mechanism as claimed in claim 7,
wherein the first impact-absorbing element further comprises:
a first impact-absorbing element second hollow portion, formed on the first impact-absorbing element body and has an elongated structure,
wherein the first impact-absorbing element second hollow portion penetrates the first impact-absorbing element body, and the first impact-absorbing element second hollow portion is perpendicular to the first impact-absorbing element first hollow portion.

9. The optical element driving mechanism as claimed in claim 8,
wherein the first impact-absorbing element first hollow portion is formed on the first impact-absorbing element first surface, and the first impact-absorbing element second hollow portion is formed on the first impact-absorbing element second surface.

10. The optical element driving mechanism as claimed in claim 2,
wherein the Young's modulus of the first contacting element is different from the Young's modulus of the first impact-absorbing element,
wherein the Young's modulus of the first fixing element is different from the Young's modulus of the first impact-absorbing element.

11. The optical element driving mechanism as claimed in claim 10,
wherein the Young's modulus of the first contacting element is greater than the Young's modulus of the first impact-absorbing element,
wherein the Young's modulus of the first fixing element is greater than the Young's modulus of the first impact-absorbing element,
wherein the Young's modulus of the first fixing element is the same as the Young's modulus of the first contacting element.

12. The optical element driving mechanism as claimed in claim 2, further comprising:
a second stopping assembly, limiting the movement range of the first movable part, wherein the second stopping assembly comprises:
a second contacting element;
a second impact-absorbing element, wherein when the first movable part is at a second extreme position, the second impact-absorbing element is in contact with the second contacting element; and
a second fixing element, fixing the second impact-absorbing element.

13. The optical element driving mechanism as claimed in claim 12,
wherein the first driving assembly drives the first movable part to move relative to the fixed part along an optical axis with a first driving force,
wherein the first stopping assembly, the first movable part, and the second stopping assembly are arranged along the optical axis,
wherein the first stopping assembly, the first driving force, and the second stopping assembly overlap with each other along the optical axis.

14. The optical element driving mechanism as claimed in claim 12,
wherein the second impact-absorbing element further comprises:
a second impact-absorbing element body;
a second impact-absorbing element first surface, located on the second impact-absorbing element body and facing the second contacting element; and
a second impact-absorbing element concave-convex structure, formed on the second impact-absorbing element first surface,
wherein when the first movable part is located at the second extreme position, the second impact-absorbing element concave-convex structure is in contact with the second contacting element.

15. The optical element driving mechanism as claimed in claim 14,
wherein the second impact-absorbing element further comprises:
a second impact-absorbing element second surface,
wherein the second impact-absorbing element first surface extends away from the second impact-absorbing element body,
wherein the second impact-absorbing element second surface extends away from the second impact-absorbing element body,
wherein the extending direction of the second impact-absorbing element first surface is opposite to the extending direction of the second impact-absorbing element second surface.

16. The optical element driving mechanism as claimed in claim 12, further comprising:
a connecting element,
wherein the second fixing element further comprises:
a first groove, recessed away from the second impact-absorbing element; and
a second groove, recessed away from the second impact-absorbing element,
wherein the concave direction of the first groove is opposite to the concave direction of the second groove,
wherein the first groove and the second groove are provided with the connecting element, and the connecting element is in contact with the second impact-absorbing element.

17. The optical element driving mechanism as claimed in claim 12, further comprising:
a second movable part, connected to a second optical element; and
a second driving assembly, driving the second movable part to move relative to the fixed part,
wherein the second movable part moves relative to the fixed part around a direction that is perpendicular to an optical axis,
wherein the fixed part comprises:
a base; and
an outer frame, provided on the base,
wherein the outer frame and the base form an internal space to accommodate the first movable part, the first driving assembly, the first stopping assembly, the second movable part, the second driving assembly, and the second stopping assembly

18. The optical element driving mechanism as claimed in claim 17,
wherein when the second movable part is at a second movable part extreme position, the second impact-absorbing element is in contact with the second movable part.

19. The optical element driving mechanism as claimed in claim 17, further comprising:
a circuit assembly, disposed on the base,
wherein in a direction that is perpendicular to the optical axis and is parallel to the base, the first movable part at least partially overlaps the circuit assembly,
wherein in the direction that is perpendicular to the optical axis and is parallel to the base, the second movable part at least partially overlaps the circuit assembly,
wherein the first driving assembly and the second driving assembly receive current from the circuit assembly to drive the first movable part and the second movable part to move relative to the fixed part, respectively.

20. The optical element driving mechanism as claimed in claim 17,
wherein the second movable part comprises:
a second movable part body, in contact with the second optical element; and
a hook portion, in contact with the second optical element, and the hook portion extends away from the second movable part body from the second movable part body,
wherein the second optical element is located between the second movable part body and the hook portion.
